(19) United States
(12) Patent Application Publication
(10) Pub. No.: US 2018/0056549 A1
(43) Pub. Date: Mar. 1, 2018

(54) EVACUABLE MOLD FOR FIBER COMPOSITE PLASTIC COMPONENTS

(71) Applicant: INFIANA GERMANY GMBH & CO. KG, Forchheim (DE)

(72) Inventor: Felix GRIMM, Erlangen (DE)

(73) Assignee: INFIANA GERMANY GMBH & CO. KG, Forchheim (DE)

(21) Appl. No.: 15/805,582

(22) Filed: Nov. 7, 2017

Related U.S. Application Data
(63) Continuation of application No. PCT/EP2016/000810, filed on Mar. 17, 2016.

(30) Foreign Application Priority Data
May 15, 2015 (DE) 10 2015 208 980.0

(51) Int. Cl. B29C 33/40; C08J 5/18; B29C 70/44; B29C 33/68

(52) U.S. Cl. CPC B29C 33/40; C08J 5/18; B29C 70/443; B29K 2307/04; C08J 2377/02; C08J 2327/18; C08J 2323/08; B29C 33/68

(57) ABSTRACT

Evacuable, stable mold having a design obtained by thermal deformation at temperatures ≦240° C. and corresponding to a fiber composite plastic component to be produced, consisting of an at least two-layered thermoplastic, vacuum-tight plastic film from a surface layer which is made of at least one thermoplastic polyamide or copolyimide, which has optionally functional groups, and a separating layer which form the inner side and is made of at least one thermoplastic fluorinated copolymer which has functional groups.

This application is a Continuation of International Patent Application No. PCT/EP2016/000810, filed Mar. 17, 2016, which claims foreign priority benefit under 35 U.S.C. §119 of German Patent Application 10 2015 208 908.0 filed May 15, 2015 the content of which is incorporated herein by reference.

The present invention relates to a stable evacuable mold with a shape which by virtue of thermoforming corresponds to the shape of the respective fiber-composite plastics component to be produced therewith, and made of a vacuum-tight thermoplastic film made of a layer a) as surface layer made of at least one thermoplastic polyamide or copolyamide optionally having functional groups and a layer b) as release layer on the internal side of the mold made of at least one thermoplastic fluorocopolymer, preferably tetrafluoroethylene copolymer, which has functional groups.

### BACKGROUND OF THE INVENTION

It is known that the technique known as vacuum bagging can be used to produce fiber-composite plastics components, including those of complicated shape, for a very wide variety of applications, e.g. for aerospace, the vehicle industry or the wind-turbine industry. In this technique, laminates made of reinforcing fibers, preferably carbon fibers or glass fibers, saturated with a curable plastics resin, are packed together with a vacuum-tight shaping mold into a vacuum-tight bagging. Evacuation not only forces the laminate into the vacuum-tight shaping mold but also provides sufficient compaction of the laminate therein, thus minimizing the number of cavities in the laminate and permitting escape of gas inclusions or air inclusions. The entire evacuable apparatus comprising a bagging capsule and a shaping mold, with the molded fiber-containing plastics laminate, is then placed in an autoclave under pressure with heating to the curing temperature of the plastics resin until the curable plastics resin has been cured and the finished fiber-composite plastics component can be removed from the bagging.

The vacuum-tight bagging capsule for the fiber-plastics-resin laminate that is to be molded and cured usually comprises not only a vacuum-tight plastics film as external bagging but also besides the shaping mold equipped with a release layer, a layer structure arranged on the vacuum-tight plastics bagging made of, from the outside to the inside, a layer of an air-permeable nonwoven fabric, a release layer, optionally an adjoining layer to absorb the excess plastics resin forced out of the fiber-plastics-resin laminate by the vacuum, and a further, preferably perforated, release layer directly adjoining the laminate to be cured. This process for the production of fiber-composite plastics components is therefore not only relatively complicated but also time-consuming and costly because of the before mentioned materials and work involved.

There is therefore a need to simplify the before mentioned vacuum-bagging technology while avoiding any losses of quality of the resultant fiber-composite plastics components.

It was therefore an object of the present invention to maximize simplicity of vacuum-bagging technology for the production of fiber-composite plastics components, and thus reduce costs, while not in any way impairing the quality of the fiber-composite plastics components, which have to satisfy extremely stringent safety requirements.

### SUMMARY OF THE INVENTION

This object is achieved via the use of a stable evacuable mold with a shape which by virtue of thermoforming corresponds to the shape of the respective fiber-composite plastics component to be produced therewith, and is made of a vacuum-tight plastics film made of

a) a surface layer made of at least one thermoplastic polyamide or copolyamide which optionally has functional groups and

b) a release layer forming the internal side of the mold and made of at least one thermoplastic fluoro-copolymer, preferably tetrafluoroethylene copolymer, which has functional groups, whereby the plastics film has no tie layer between the layer a) and the layer b).

The vacuum-tight thermoplastic film used according to the invention can be used to produce stable evacuable molds by thermoforming, the shape of which corresponds precisely to the fiber-composite plastics component to be produced therein. There is moreover no need for the before mentioned further layer structure which is usually required in the vacuum-bagging technology for the production of fiber-composite plastics components and comprises additional release layers, plastics-resin-absorption layers and air-permeable nonwoven-fabric layers.

The inventively used mold has the necessary vacuum-tight property allowing evacuation for compacting the laminate arranged in the bagging and made of fibers and of curable plastics resin, for shaping of said laminate into the precise required shape of fiber-composite plastics components, even those with a complicated shape.

The mold moreover retains adequate stability during the curing process, which is carried out under pressure and at elevated temperature for a number of hours to convert the fiber-plastics-resin laminate to the finished component, and can be removed without difficulty from the fiber-composite plastics component obtained after curing of the plastics resin. One of the reasons for the smooth running of this procedure is that the plastics film used for the production of the stable evacuatable mold exhibits excellent adhesion between the layer a) and the layer b), without any need for a tie layer between the layer a) and the release layer b). Nor is the adhesion impaired during the lengthy curing of the fiber-plastics laminate. Accordingly, the surface structure of the cured fiber-composite plastics component exhibits no damage and satisfies the stringent requirements relating to appearance and safety.

The plastics film used according to the invention moreover has a softening point ≦240° C., and the inventive evacuable mold can therefore be produced by a thermoforming process with conventional thermoforming equipment, e.g. according to deep-drawing methods, preferably under vacuum and/or mechanical action, even if the shape of the fiber-composite plastics component to be produced in the mold is complicated.

The at least two-layer inventively used thermoplastic film is vacuum-tight, and the vacuum-tight properties here are obtained not only via the polyamide layer a) but also via the release layer b). Accordingly, the inventive mold can be kept evacuated for long periods, or can be kept vacuum-tight for long periods.

The thermoplastic film used inventively has a softening point that is higher by at least 10° C. than the curing temperature of the fiber-reinforced, curable plastics laminate of which the fiber-composite plastics component is produced, and the inventive mold therefore also remains stable during the curing phase, and retains its shape. Adequate stability of the inventive mold is moreover ensured because the plastics film used for the production of the inventive mold has an excellent modulus of elasticity.

The inventively used plastics film preferably has two layers, and preferably exhibits an adhesion that is sufficient to prevent separation of the layers according to the conventional test conditions for determining adhesion, thus preventing, as stated above, delamination of the layer a) from the layer b) when the plastics film used according to the invention is subjected to stress conditions. Therefore, there is no need for any tie layer between the layer a) and the layer b), and therefore no tie layer is present.

### DETAILED DESCRIPTION

Said adhesion without any tie layer is achieved between the layer a) and the layer b) of the plastics film used according to the invention, because the preferably used thermoplastic tetrafluoroethylene copolymer for the production of the layer b) and optionally the polyamide or copolyamide of the layer a) have functional groups, whereby preferably such functional groups of the two layers can, and are intended to, react with one another.

Accordingly, the layer a) can be based on at least one thermoplastic, aliphatic, semiaromatic or aromatic polyamide or copolyamide, or on a mixture of at least two of the polymers mentioned, where the polyamide or the copolyamide can optionally be composed of at least one at least trifunctional polyamine or an at least trifunctional polycarboxylic acid in a quantity of from 0.01 to 5 mol %.

It is preferable that the layer a) is composed of at least one thermoplastic aliphatic polyamide or copolyamide, preferably made of an alkylenediamine having from 4 to 8 C atoms and an aliphatically carboxylic acid having from 6 to 14 C atoms, and/or made of a lactam, preferably having from 4 to 6 C atoms, particularly preferably of an ε-caprolactam (PA-6), or of a polyamide made of hexamethylenediamine and adipic acid (PA-6,6), of a hexamethylenediamine and sebacic acid, or of a hexamethylenediamine and dodecanedioic acid, or of a copolyamide made of hexamethylenediamine, adipic acid and ε-caprolactam, preferably having from 5 to 50% by weight of ε-caprolactam units (PA-6,6/6), of a semiaromatic polyamide made of an alkylenediamine having from 4 to 6 C atoms and terephthalic acid or isophthalic acid, preferably a polyamide made of hexamethylenediamine and terephthalic acid (PA-6T) or of hexamethylenediamine and isophthalic acid (PA-6I), or of a thermoplastic, aromatic polyamide composed of aromatic diamines and aromatic dicarboxylics, preferably of isophthalic acid or terephthalic acid and phenylenediamine, where the softening point of the respective polyamide or copolyamide must be ≦240° C.

Mixtures made of PA-6 or PA-6,6 and respectively preferably from 5 to 20% by weight, based on the entire mixture, of a semiaromatic polyamide, preferably of a PA-6I, cause in particular an improved thermoformability.

Each of the polyamides or copolyamides or mixtures thereof can optionally comprise the abovementioned functional groups, if at least trifunctional compounds are also used for the polycondensation process.

As mentioned before, the layer b) is based on a thermoplastic fluorocopolymer, preferably tetrafluoro-ethylene copolymer.

Suitable fluorocopolymers are in particular tetrafluoro-ethylene copolymers which have

α) copolymerized units of tetrafluoroethylene,

δ) copolymerized units of at least one fluorinated monomer differing from tetrafluoroethylene, selected from the group consisting of
CF₂═CFOR¹, wherein R¹ is a C₁₋₁₀ perfluoroalkyl moiety which can comprise an oxygen atom,

of CF₂═CF(CF₂)ₚOCF═CF₂, wherein p is 1 or 2,

of perfluoro (2-methylene-4-methyl-1,3 dioxolane) and
CH₂═CX³ (CF₂)_{Q}X⁴, wherein X³ is a hydrogen atom or a fluorine atom, Q is an integer from 2 to 10 and X⁴ is a hydrogen atom or a fluorine atom,

β) copolymerized units of nonfluorinated monomers, preferably C₂-C₄ olefins, preferably of ethylene or propylene or of vinyl ester or vinyl ether, preferably vinyl acetate and

γ) copolymerized units of monounsaturated aliphatic dicarboxylic acid or cyclic anhydrides thereof,

wherein a fluorocopolymer used according to the invention, preferably tetrafluoroethylene copolymer, must not necessarily be composed of all of the copolymerized units α)- γ) mentioned.

Preferably that the functional groups of the fluorocopolymer, preferably tetrafluoroethylene copolymer, are derived from polymerized units of γ) monounsaturated, aliphatic dicarboxylic acids, for example itaconic acid, citraconic acid, or maleic acid, or cyclic anhydrides thereof, for example maleic anhydride, itaconic anhydride or citraconic anhydride. The proportion of these polymerized units is preferably from 0.01 to 5 mol %, whereby the sum of all polymerized units must always be 100 mol %.

The layer b) is thus composed of a fluorocopolymer, preferably of a tetrafluoroethylene copolymer, composed of polymerized units of α) tetrafluoroethylene, β) C₁-C₄- olefins, preferably ethylene, and γ) monounsaturated polycarboxylic acids or cyclic anhydrides thereof, preferably itaconic acid, itaconic anhydride, citraconic acid, citraconic anhydride, maleic acid or maleic anhydride, and the tetrafluorocopolymer is composed of from 50 to 90 mol % of α)-units, of from 10 to 50 mol % of β)-units, preferably ethylene units, and of from 0.01 to 5 mol % of γ)-units, whereby the sum of the units α)+β)+γ) must always be 100 mol %.

For the composition of the layer b), preference is also given to a tetrafluoroethylene copolymer of polymerized units α), γ) and δ), which copolymer is composed of from 50 to 99.8 mol % of α)-units, from 0.01 to 5 mol % of γ)-units and from 0.1 to 49.99 mol % of γ)-units, in each case based on the sum of α), γ) and δ).

Another preferred tetrafluoroethylene copolymer for the composition of the layer b) is a tetrafluoroethylene copolymer made of polymerized units α), β), γ) and δ), where the copolymer is composed of from 50 to 90 mol % of α)-units, from 5 to 35 mol % of β)-units, from 0.1 to 20 mol % of δ)-units and from 0.01 to 5 mol % of γ)-units, in each case based on the sum of α)-δ).

It is also possible to provide the tetrafluoroethylene copolymer with functional groups by a chemical treatment, corona discharge treatment or plasma discharge treatment to provide free radicals to the surface of the layer b) and by using a conventional method for grafting unsaturated dicarboxylic acids, cyclic anhydrides thereof and/or epoxides or hydroxy groups thereto in an amount that the functional groups are in a proportion of from 0.01 to 5 mol %, based on 100 mol % of the tetrafluoroethylene copolymer, before bonding layer b) to the layer a).

As mentioned above, the plastics film used according to the invention preferably has two layers, and has no tie layer in between. In case both the layer a) and the layer b) have functional groups, it is therefore advisable that functional groups present are of the type that they can react with each another. Examples of these are carboxy groups, hydroxy groups, cyclic anhydride groups and amino groups.

The thermoformability and stability of the plastics film used according to the invention are influenced by the overall thickness and the thickness ratio of the layer a) to the layer b). The total thickness of the plastics film not yet thermoformed is preferably at least 250 μm, particularly preferably at least from 400 to 700 μm, whereby the thickness ratio of the layer a) to the layer b) is in the range of from 95:5 to 70:30.

The plastics film used according to the invention can be produced by extrusion, preferably by coextrusion. It is particularly preferable that the plastics film used according to the invention is produced in the form of cast film by extrusion, preferably coextrusion, through a flat-film die, whereupon an excellent adhesion is obtained.

The plastics film used according to the invention is hydroscopic because of the polyamide layer a), and is preferably stored in a packaging impermeable to moisture, after its drying, and preferably again dried before thermoforming. Immediately after the inventive mold has been produced and cooled, this is also stored under conditions that exclude moisture, and optionally again dried before being used for the production of a fiber-composite plastics component.

Because of the unfluorinated units of the tetrafluoroethylene copolymer the softening point of the plastics film used according to the invention is ≦240° C.

It is thus possible to thermoform the plastics film in conventional forming equipment, preferably by deep-draw thermoforming under heating to the forming temperature, to produce the inventive mold which thermoformed mold has the shape corresponding to the fiber-composite plastics component to be produced in the inventive mold. The temperature for thermoforming of the plastics film is preferably ≦240° C., particularly preferably in the range of from 210 to 240° C.

The thermoforming procedure can be carried out under vacuum and optionally under mechanical assistance, for example, of a ram.

The plastics film used according to the invention is preferably transparent, and it is therefore also possible to provide transparent molds for the production of fiber-composite plastics components. This allows inspection during curing of the impregnated fiber-plastics laminates, to ensure a defect-free production.

In order to avoid embrittlement of the mold during thermoforming, it is advantageous to add to the polyamide antioxidants, e.g. sterically hindered phenols, phosphites or sterically hindered amines. This provides long-term antioxidative thermal stabilization, i.e. a prevention of a thermal polymer degradation which can lead to embrittlement of the mold during curing of the fiber-composite plastics component. Thermal stabilization can also be achieved by adding Cu(II) compounds, such as Cu(II)KI complexes. Addition of as little as from 1 to 10% by weight, preferably from 1 to 5% by weight, of the additives mentioned can achieve adequate stabilization against embrittlement and any undesired discoloration of the mold. The thermoformability of the film used according to the invention can also be further improved by the use of one of the before mentioned mixtures of polyamides comprising a high-viscosity amorphous polyamide such as PA-6I for the production of the polyamide layer a).

It is thus possible to prevent any undesired softening or disruption of the film web that might occur during thermoforming.

It is moreover possible to add conventional quantities of conventional processing aids such as lubricants or antistatic agents into the film used according to the invention.

It is particularly preferable that the total thickness of the thermoplastic film that has not yet been thermoformed is at least 250 μm, preferably up to 700 μm, where the thickness ratio of the layer a) to the layer b) is in the range from 95:5 to 70:30.

A possibility for the production of large-surface-area fiber-composite plastics components which may have a repeating shape is to juxtapose identically shaped mold segments which can be bonded to one another in the overlapping region of two segments, preferably by heat-sealing in order to prepare a respective mold.

The inventive mold has at least one evacuation equipment, which after being filled with the plastics-resin-impregnated fiber laminate, is closed with a further, vacuum-tight mold—the sealing mold—to provide an entire vacuum-tight mold.

The design of this second (closing) mold for the vacuum-tight sealing of the inventive mold can preferably differ from the inventive mold.

This “closing mold” preferably has the shape of a panel or of a shaping mold on which the plastics-impregnated fiber laminate is first placed before the vacuum-tight closing with the inventive mold. To this end, the said closing mold must have a surface provided with release agents, and must maintain its original flexural strength during the entire production process, particularly in the evacuated condition of the entire mold, in order to avoid impairment of the inventive mold and thus of the composite component to be produced. If the flexural stiffness of the closing mold is not sufficient, there is specifically the risk that the fiber-composite plastics molding will not have the desired shape.

Another possibility, however, is in case the fiber-composite plastics component should have a different shape on its two surfaces, to use a closing mold likewise made of a plastics film used according to the invention with a shape appropriate to the shape of such second surface. It is likewise possible to introduce the plastics film according to the invention between the shaping mold and the laminate, for example in order to omit use of conventional release agents (solvent-containing or water-based release agents). It is of course also possible, if necessary, that the entire closing mold has a concave or convex shape, if this is necessary for the shaping of the fiber-composite plastics component. Shaping can be achieved by folding, or folding-together, of appropriate mold halves.

As stated before, the production of the fiber-composite plastics component is carried out as follows: the fiber laminate impregnated with the curable plastics resin, preferably a curable epoxy resin, is provided on the closing mold, and then the inventive mold is combined with the closing mold, to give the entire mold, and the system is sealed so that it is vacuum-tight. A vacuum is applied in order to compress the inventive mold, with compaction of the fiber material. While the vacuum is maintained, the entire mold with the molded laminate is placed in an autoclave and heated to the curing temperature of the curable plastics resin, and retained for the entire curing time, mostly a number of hours.

Alternatively to the use of an autoclave it is possible to operate with pressure in a press or to operate under atmospheric pressure (i.e. oven curing).

Curing can also be achieved by the action of microwave radiation.

After the curing time, and after cooling, the fiber-composite plastics component is removed from the entire mold and, as far as possible under exclusion of moisture, packed for final use.

Fibers used for the production of the composite components are preferably carbon fibers or glass fibers.

The inventive mold can be used to produce fiber-composite plastics components, preferably carbon-fiber composite plastics components, which in particular can be used as components for means of transport of any type, preferably for aircraft, spacecraft, trains or motor vehicles, or as components for wind turbines, preferably as rotor blades.

Determination of Adhesion

Adhesion between the layer a) and the layer b) is determined by testing test strips of a multilayer film used according to the invention, each with width 15 mm and length about 150 mm. Each test strip is fixed in a tensile tester in such way that the angle formed by the strips to be separated from one another (layer a) and layer b)) is about 180° C., and the strips are then separated from one another. The maximal and average separation force is determined across the measurement distance. The measurement equipment used for the test is a computer-controlled tensile tester. Adhesion is determined here by plotting force against displacement. The force measured in N corresponds to the force required to achieve full separation of the layers (layer a) and layer b)) of the test strip.

### EXAMPLE

A two-layer cast film is produced by coextrusion of PA-6 comprising 5% by weight of PA-6I as layer (a) and of an ethylene/tetrafluoroethylene copolymer with 0.5 mol % of γ- and δ-units incorporated into the polymer. The thickness of the polyamide layer a) is 400 μm and the thickness of the release layer b) is 100 μm. The coextruded film could be thermoformed very successfully at 229° C., and exhibits excellent adhesion: it could not be separated into two layers according to the “Determination of adhesion” test described before, either mechanically or with the aid of test adhesive tapes. Delamination was not possible.

What is claimed is:

1. A stable evacuable mold with a shape obtained by thermoforming at temperatures ≦240° C. and corresponding to the respective fiber-composite plastics component to be produced therewith, and made of an at least two-layer vacuum-tight thermoplastic film comprising
a) a surface layer made of at least one thermoplastic polyamide or copolyamide which optionally has functional groups, and
b) a release layer forming the internal side of the mold and made of at least one thermoplastic tetrafluoroethylene copolymer, which has functional groups, composed of
b1) α) copolymerized units of tetrafluoroethylene and
γ) copolymerized units of monounsaturated aliphatic dicarboxylic acids or cyclic anhydrides thereof, and also
δ) copolymerized units of at least one fluorinated monomer differing from tetrafluoroethylene, selected from the group consisting of
CF₂═CFOR¹, where R¹ is a C₁₋₁₀ perfluoroalkyl moiety which can comprise an oxygen atom,
CF₂═CF(CF₂)ₚOCF═CF₂, where p is 1 or 2,
perfluoro (2-methylene-4-methyl-1,3 dioxolane) and CH₂═CX³(CF₂)_{Q}X⁴, where X³ is a hydrogen atom or a fluorine atom, Q is an integer from 2 to 10 and X⁴ is a hydrogen atom or a fluorine atom, and/or
β) copolymerized units of C₂-C₄ olefins, or
b2) an olefin/tetrafluoroethylene copolymer which has been modified by free-radical grafting of from 0.01 to 5 mol % of carboxy groups, hydroxy groups, ester groups, isocyanate groups, epoxy groups, amide groups or cyclic anhydride groups,
where the plastics film has no tie layer between the layers a) and b).

2. The mold as claimed in claim 1, wherein the layer a) is based on at least one thermoplastic aliphatic, semiaromatic or aromatic polyamide or copolyamide or of a mixture of at least two of the polyamides mentioned, a copolyamide of hexamethylenediamine, adipic acid and ε-caprolactam, or a mixture of PA-6 or PA-6,6 and from 5 to 20% by weight of a semiaromatic polyamide with softening point ≦240° C., whereby the polyamide or copolyamide units are composed of an at least trifunctional polyamine or of an at least trifunctional polycarboxylic acid in a quantity of from 0.01 to 5 mol %, based on 100 mol % of the copolyamide.

3. The mold as claimed in claim 1 wherein the layer b) is composed of a tetrafluoroethylene copolymer made of polymerized units of α) tetrafluoroethylene, β) C2-C4-olefins, and γ) monounsaturated polycarboxylic acids or cyclic anhydrides thereof, whereby the tetrafluorocopolymer is composed of from 50 to 90 mol % of α)-units, of from 10 to 50 mol % of (β)-units, and of from 0.01 to 5 mol % of γ)-units, where the sum of the units α)+β)+γ) must always be 100 mol %.

4. The mold as claimed in claim 1 wherein the layer b) is composed of an ethylene/tetrafluoroethylene copolymer which has been modified by free-radical grafting of at least from 0.01 to 5 mol % of carboxy groups, hydroxy groups, ester groups, isocyanate groups, epoxy groups, amide groups or maleic anhydride groups.

5. The mold as claimed in claim 1 wherein the layer b) is composed of a thermoplastic tetrafluoroethylene copolymer made of
α) copolymerized units of tetrafluoroethylene,
δ) copolymerized units of at least one fluorinated monomer differing from tetrafluoroethylene, selected from the group consisting of
CF₂═CFOR¹, where R¹ is a C₁₋₁₀ perfluoroalkyl moiety which can comprise an oxygen atom,
CF₂═CF(CF₂)ₚOCF═CF₂, where p is 1 or 2,
perfluoro(2-methylene-4-methyl-1,3 dioxolane) and CH₂═CX³(CF₂)_{Q}X⁴, where X³ is a hydrogen atom or a fluorine atom, Q is an integer from 2 to 10 and X⁴ is a hydrogen atom or a fluorine atom,
β) copolymerized units of C₂-C₄ olefins and
γ) copolymerized units of monounsaturated aliphatic dicarboxylic acid or cyclic anhydrides thereof.

6. The mold as claimed in claim 5, wherein the layer b) is composed of a tetrafluoroethylene copolymer made of polymerized units α), γ) and δ), where the copolymer has from 50 to 99.8 mol % of α)-units, from 0.01 to 5 mol % of γ)-units and from 0.1 to 49.99 mol % of δ)-units, based in each case on α), γ) and δ).

7. The mold as claimed in claim 5, wherein the copolymer is composed of from 50 to 90 mol % of α)-units, from 5 to 35 mol % of β)-units, from 0.1 to 20 mol % of δ)-units and from 0.01 to 5 mol % of γ)-units, based in each case on α)-δ).

8. The mold as claimed in claim 1, wherein the mold has at least one closable evacuation system.

9. A method for the production of a fiber-composite plastics component with the mold of claim 1.

10. The method of claim 9, wherein the mold produced from the thermoplastic film has a softening point that is higher by at least 10° C. than the curing temperature of the fiber-composite plastics component hardened in the mold.

11. The method of claim 10, wherein the fiber-composite plastics component is a carbon-fiber-composite plastics component for aircraft, spacecraft, trains or motor vehicles, or a component for wind turbines.
